(19) United States
(12) Patent Application Publication
(10) Pub. No.: US 2007/0137283 A1
(43) Pub. Date: Jun. 21, 2007

(54) Lateral manifold for a multiple sample location sensor and method for collection

(76) Inventors: Adam Giandomenico, Los Angeles, CA (US); Michael Theodore Mower, Grants Pass, OR (US); Rocco D. Pochy, Milpitas, CA (US); Scott H. Salton, Fremont, CA (US); Thomas C. Saunders, Milpitas, CA (US)

Correspondence Address: OBJECT MODULE, INC., 801 GRAND AVE, SUITE 350-166, DES MOINES, IA, 50309, US

(21) Appl. No.: 10/560,083

(22) PCT Filed: Jul. 11, 2005
(86) PCT No.: PCT/US05/24177

§ 371 Date: Dec. 9, 2005

Related U.S. Application Data
(60) Provisional application No. 60/521,851, filed on Jul. 11, 2004.

(51) Int. Cl. G01N 15/00

(52) U.S. Cl. 73/28.01

(57) ABSTRACT

A lateral manifold (10) for a fluid sensor (100) enables the fluid sensor (100) to sample multiple locations (70) and distinguish which location is being sampled. The design minimizes space, has no unused plumbing, allows for multiple sample tubes (51-55) to provide continuous flow, and enables a method for collecting samples from multiple locations (70).

### FIELD OF THE INVENTION

The present invention relates to the design of a fluid sensor capable of sampling multiple locations and distinguishing which location is being sampled, while using little space and the method for doing so.

### BACKGROUND OF THE INVENTION

Because of the small size of semiconductors in the manufacturing of semiconductors it is critical that particles not be permitted to contaminate the process. Particles as small as 1 μm and less can contaminate the process. The first generation of semiconductor manufacturing plants were built with the so-called open ballroom concept. Here an attempt to keep the entire plant free of particles was made. Each successive generation of manufacturing plant design has made the clean space where particles are eliminated smaller and smaller. The latest design of manufacturing plants has what are called mini-environments. These environments are just big enough to contain the tools that work on the silicon wafers. Silicon wafers are transported from tool to tool in containers that attach to the tools in a process that is similar to two space ships docking. The goal is to eliminate the possibility of particles entering into either the wafer's transport pod or the tool's mini-environment.

There is a need to constantly monitor the tool's mini-environment. There are two main purposes for this. First, if particles are entering the tool's mini-environment then the source(s) of the contamination needs to be identified and eliminated. Second, if a tool's mini-environment is contaminated then the process may need to be stopped so that wafers are not run through the tool's mini-environment and destroyed by the particle contamination.

The tool's mini-environment is essentially no larger then necessary to contain the tool. However, even in this small environment there are many different areas within the tool. For example, there are areas where the wafer pods couple with the tool to make the wafers available for the tool to process, and there are areas where the tool is actually working on the wafer where particles may be generated. This creates many environments even within the tool's very limited mini-environment. Each of these environments needs to be monitored for particle contamination.

One motivation for the present invention has been described above. It should be noted that there are many other applications in which a single sensor needs to be connected to many sampling points and where there needs to be a continuous draw of fluid from the sampling points to prevent build up that would lead to false positives. The use of a single sensor rather than attaching a sensor to each of the sample points has many advantages. First, the sensor can be expensive and purchasing many of the sensors to monitor each area may be prohibitive. Second, there may be limited space so that there simple is not enough room for the multiple sensors. Third, the use of a single sensor lessens the maintenance that must be performed on the system as a whole.

U.S. Pat. No. 6,615,679 issued to Knollenberg et al. on Sep. 9, 2003 illustrates a method for monitoring multiple locations with a single sensor. However, this method does allow for distinguishing from which of the sample locations the contaminates came from.

Relevant art will now be discussed. The basic design of a shared sensor for multiple sample locations is illustrated in FIG. 1. There are five sample tubes (50) that lead from sample locations (70) to the sensor (100) via the manifold (10). The manifold (70) switches between the different sample tubes (50) in some fashion and the manifold (70) allows for a continuous flow from each of the sample tubes (50) to either the sensor (100) or the purge tube (30). This continuous flow is necessary so that there is not stagnation in the sample tubes (50) that might lead to a build up of contamination and thus lead to unreliable results when the manifold (10) selects the sample tube (50) for sampling. In FIG. 1, sample tube 52 is flowing from the sample location 72 through sample tube 52, through the manifold (10), and then finally through the sensor (100). The other sample tubes (51, 53, 54, 55) are flowing from their respective sample locations (71, 73, 74, 75) through the manifold (10), and then finally out through the purge tube (30).

So, the manifold (10) provides two functions. First, a means to switch between the sample tubes (50) to the sensor (100), and second a means for each of the non-selected tubes (51, 53,54,55) to have a continuous flow out the purge tube (30). The selected tube (52) can either be selected manually or may be selected in some multiplexed method whereby each sample tube (50) is selected in succession for some specified period of time and the results of the sensor (100) acted upon in some manner. Many things can be done with the results of the sensor (100). For example, all of the results could be recorded for later analyzing, or the results could be sent to a central location for monitoring. An alarm (not shown) could be attached to the sensor (100) to alert the operator (not shown) that the sensor (100) has detected an unacceptable level of a contaminate.

The present invention is concerned with the design of the manifold (10) and a method of sampling the design enables. The design challenges are to keep the sample tubes flowing to prevent contamination build up, to use little space as possible, and to ensure there are not dead areas in the design that may create areas that contamination may adhere to. And finally, an inexpensive solution is always important.

FIG. 2 illustrates a valve (90) based manifold (10) implementation of a manifold that is known to the industry. It uses electrically operated valves (90) as the means to select which sample tube (50) is selected to be feed to the sensor (100). The advantage of this design is that the electronically operated valves (90) can be tightly packed together. However, there are several disadvantages to this design. The inherent constriction of the flow through the valve and the inherent dead space (130) in the plumbing creates opportunities for contaminates to be trapped. Further, the electronics for switching between sample tubes (50) must be sophisticated to insure proper firing of the valves so as not to mix samples from the sample tubes (50).

FIG. 3 illustrates a rotary manifold (10) that is another implementation of a manifold known to the industry. Here the sample ports are arranged on a fixed front plate (15) in a circular fashion. The sample tube (50) is selected by a stepper motor (not shown) rotating the manifold arm (13) to a sample tube (50). Sample tube 52 is selected in FIG. 3. The manifold arm (13) rotates about an axis of rotation (11) in a direction (12). Each of the non-selected sample tubes (51, 53, 54, 55) continues to flow into the manifold chamber (14) and discharges out the purge tube (30).

The design illustrated in FIG. 3 has several advantages over the valve based manifold (10) illustrated in FIG. 2. First, the selection of the sample tube (50) can be controlled with a single stepper motor (not shown). Second, there is no dead plumbing for contaminates to build up. The disadvantages of this design are that the manifold chamber (14) is large for the number of sample tubes (50) and it can be difficult to maintain positional accuracy with the manifold tube (14) as many designs require that the manifold tube (14) align on two dimensions.

Thus a need has been established for a particle sensor that can sample multiple locations and report the results of the sensor for each sample location without occupying a large amount of space.

### SUMMARY OF THE INVENTION

A lateral manifold for a fluid sensor is illustrated that enables the fluid sensor to sample multiple locations and distinguish which location is currently being sampled. The design uses little space and has no unused plumbing. Further, the design allows for the multiple sample tubes to continuous flow so as not to build up contaminates and provide accurate measurement from the sensor.

The design uses a hollow arm that is rotated laterally to the selected sample port. A single motor is all that is need to provide the lateral motion for the manifold arm. The lateral design allows the manifold to be flat and minimizes the volume of the manifold for a given number of sample ports.

The lateral manifold enables a method for sampling multiple locations with a single sensor and being able to distinguish between the locations.

### BRIEF DESCRIPTION OF THE DRAWING(S)

FIG. 1 shows relevant art of a simple manifold system with a sensor.

FIG. 2 shows relevant art of an electrically operated valve manifold system with a sensor.

FIG. 3 shows relevant art of a front and side view of a rotary manifold system.

FIG. 4 is a top view of the present invention, the lateral manifold.

FIG. 5 is a side view of the present invention, the lateral manifold.

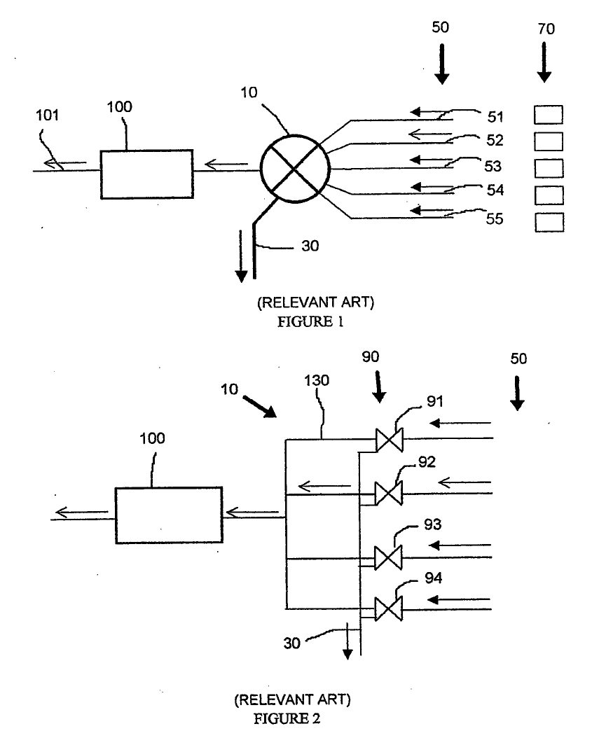

### DETAILED DESCRIPTION OF THE PREFERRED EMBODIMENT(S)

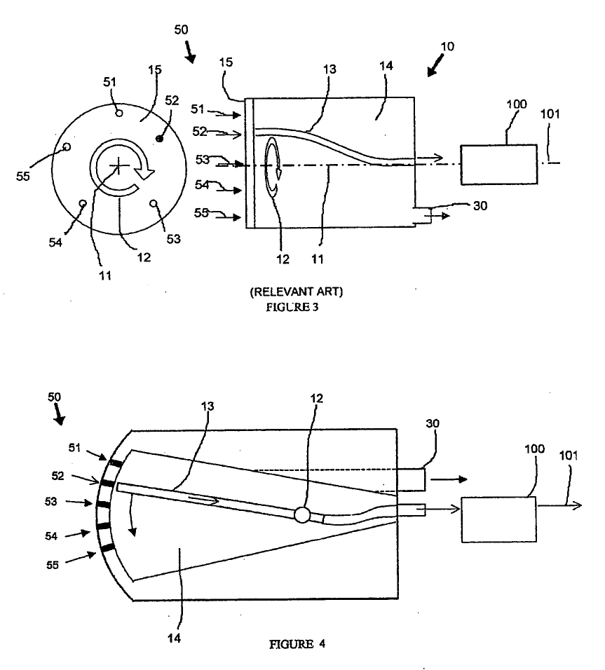

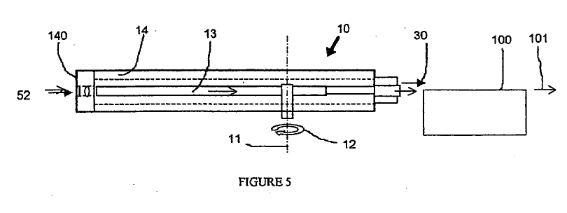

The preferred embodiment of the present invention is illustrated in FIGS. 4 and 5. Referring to FIG. 4, the lateral manifold (10) has a manifold arm (13) that is turned about an axis (12) by a motor (not shown). The manifold arm (13) needs to move only laterally to reach each sample tube (50) unlike the manifold arm (13) in the rotary manifold (10) illustrated in FIG. 3. In FIG. 4, sample tube 52 is selected and thus the flow from sample tube 52 flows through the manifold arm (13) and to the sensor (100). The unselected sample tubes (51, 53, 54, 55) continue to flow into the manifold chamber (14) and out the purge tube (30). The curvature of the face (140) is defined by the rotation of the manifold arm (13). This curvature then allows the manifold arm (13) to tightly fit each of the sample tubes (50).

By using a lateral rather than a circular motion with the manifold arm (13) the volume of the manifold chamber (14) can be greatly decreased. This is so as there is no wasted volume with a lateral arrangement of the manifold arm (13). Each sample tube (50) has an opening that defines a surface area that is set by other parameters of the test equipment such as the pressure difference between the sample tubes (50) and the manifold (10). So, there is a certain volume taken by the sample tubes (50) being attached to the face (50) of the manifold. With a lateral arrangement the sample tubes (50) can be placed as tightly as possible with no wasted space either above or below, them, thus creating a minimum size for the face (140) of the manifold. Now, given this minimum sized face (140), the manifold arm (13) length then defines the remainder of the volume of the manifold (10). The manifold arm (13) is the minimum length possible to reach each of the sample tubes (50), so the volume of the manifold (10) is minimized.

Another advantage to the preferred embodiment is that it draws the purge flow (101) from each of the sample tubes (50) equally. This occurs, as each of the sample tubes (50) is the same distance to the purge flow (101). This is very important in applications where it is important to know the relative differences between the sensor measurements between the sample tubes (50) and is also important to minimize the amount draw needed through the purge flow (101). As with unequal flows, then the purge flow (101) would have to be increased until the sample tube (50) with the lowest flow had a sufficiently large flow to prevent contaminate build-up. A purge flow (101) set at this level would mean that some sample tubes (101) would have flows greater then necessary to prevent contaminate build-up.

The lateral motion of the manifold arm (13) is simpler to accomplish then the rotational motion necessary with the manifold (10) design illustrated in FIG. 3. The mechanics of producing lateral motion with a single pivot point is inherently simpler then creating a rotational motion about two axes. This is an obvious point to one skilled in the art.

In the preferred embodiment, the fluid is a gas and specifically air drawn from around a tool for manufacturing of semiconductors. The sensor (100) in the preferred embodiment is a particle detector; however, the sensor could be any type of sensor for such things as temperature, humidity, or dangerous fluids.

The present invention also benefits from having an inherently flat shape as is illustrated in FIG. 5. This shape allows for the present invention to be stacked in tight locations with little or no wasted space between multiple units.

In an alternative embodiment of the present invention, there are multiple rows of sample tubes stacked on top of one anther. In this embodiment, the manifold arm (13) selects the row and then selects the sample tube (50) within that row. This embodiment minimizes space, as there are fewer manifold arms (13) for a given number of sample tubes (50). The disadvantage to this embodiment is that the manifold arm (13) then must move about two axes and the sample tubes (50) must wait a greater time between being sampled as the manifold arm (13) has many more sample tubes to sample (50).

In another alternative embodiment of the present invention, the purge flow could be attached to another sensor to insure that all the fluid passing through the system is tested.

In another alternative embodiment of the present invention, the results of the sensor are used to trigger alarms indicating that a contaminate has been detected and some action must be performed immediately.

The different sample tubes can be monitored using the following method. There are three parameters that define the method: purge, sample, and hold. The purge time is the time you wait after a sample tube (50) is selected by the manifold arm (13) before using the sensor or recording the sensor. This purge time allows the manifold arm (13) to be purged of the old sample tube (50) sample before activating the sensor. Sample time is the time that the sensor needs in order to make a measurement of the sample. Hold time is the time to wait after the sensor (100) has made its measurement before moving on to the next sample tube (50). There may be a time to wait here, as the application may not call for making as many measurements with the sensor (100) as are possible with the equipment. Purge time may vary from 5 seconds to 10 minutes depending on the type of contamination being measured by the sensor (100). Sample time varies between 5 seconds and 1 hour depending on what is being measured by the sensor (100). The hold time can vary from 0 seconds to days.

Having illustrated the present invention, it should be understood that various adjustments and versions might be implemented without venturing away from the essence of the present invention. The present invention is not limited to the embodiments described above, and should be interpreted as any and all embodiments within the scope of the following claims:

1. (canceled)

2. An apparatus for collecting and detecting particles, comprising:
a lateral manifold,
a manifold arm in communication with said lateral manifold;
sample tubes in communication with said manifold arm; and
a sensor in communication with said manifold arm.

3. The apparatus of claim 2 wherein said manifold arm is configured to be turned about an axis by a motor.

4. The apparatus of claim 3 wherein said manifold arm is configured to move laterally with a single pivot point.

5. The apparatus of claim 4 wherein said apparatus is configured to have a lateral, flat shape.

6. The apparatus of claim 5 wherein said manifold arm is configured to prevent wasted space by tightly securing said sample tubes.

7. The apparatus of claim 6 wherein said manifold arm is the minimum length needed to reach said sample tubes.

8. The apparatus of claim 2 wherein when a first sample tube of said sample tubes is selected, said first sample tube's contents flow through said manifold arm to said sensor.

9. The apparatus of claim 8 wherein when the contents of said samples tubes, but for the content of said first sample tube, flow from said lateral manifold to a purge tube.

10. The apparatus of claim 9 wherein said sample tubes are equidistant from said purge tube.

11. The apparatus of claim 2 wherein said sensor is configured to measure and evaluate contents of said sample tubes.

12. The apparatus of claim 11 wherein said sensor measures and evaluates particles, temperature, humidity and dangerous fluids of contents of said sample tubes.
